(19) United States
(12) Patent Application Publication
(10) Pub. No.: US 2015/0193048 A1
(43) Pub. Date: Jul. 9, 2015

(54) NOISE-SHIELDED CAPACITIVE TOUCH DISPLAY APPARATUS

(71) Applicant: Kuan-Yi Yang, Hsin-Chu (TW)

(72) Inventor: Kuan-Yi Yang, Hsin-Chu (TW)

(73) Assignee: PIXART IMAGING INCORPORATION, Hsin-Chu (TW)

(21) Appl. No.: 14/555,626

(22) Filed: Nov. 27, 2014

(30) Foreign Application Priority Data
Jan. 6, 2014 (TW) 103100315

(51) Int. Cl. G06F 3/044

(52) U.S. Cl. CPC G06F 3/044; G06F 2203/04107

(57) ABSTRACT

The present invention discloses a noise-shielded capacitive touch display apparatus, which includes a display panel and a capacitive touch sensor on the capacitive touch panel. The capacitive touch sensor includes plural sensing lines, driving lines and signal lines. The sensing lines are parallel with each other and extend along a first direction. The driving lines are parallel with each other and extend along a second direction, wherein the second direction is orthogonal to the first direction. There is one signal line between every two neighboring driving lines. An electric field wall is formed between each signal line and its neighboring driving line to block a noise generated from the display panel.

### CROSS REFERENCE

The present invention claims priority to TW 103100315, filed on Jan. 6, 2014.

### BACKGROUND OF THE INVENTION

1. Field of Invention

The present invention relates to a noise-shielded capacitive touch display apparatus; particularly, it relates to such a noise-shielded capacitive touch display apparatus capable of effectively blocking noises generated from the display panel so that the noises do not interfere with the operation of the touch display apparatus.

2. Description of Related Art

Please refer to FIG. 1A and FIG. 1B. FIG. 1A shows a top view of a conventional capacitive touch display apparatus. FIG. 1B shows a cross sectional view of a conventional capacitive touch display apparatus. The conventional capacitive touch display apparatus 10 shown in FIG. 1B can be, for example, a mutual capacitance type touch panel. The capacitive touch display apparatus 10 typically comprises a capacitive touch sensor 11 and a display panel 12. The capacitive touch sensor 11 is located on the display panel 12; therefore, only the capacitive touch sensor 11 of the conventional capacitive touch display apparatus 10 is shown in the top view of FIG. 1A, because the display panel 12 is located below the capacitive touch sensor 11 (as shown in FIG. 1B) and can not be seen from the top view of FIG. 1A. The display panel 12 can be, for example but not limited to, a liquid crystal display (LCD) panel or an organic light emitting diode (OLED) panel.

The capacitive touch sensor 11 includes plural driving lines DA1˜DA9 in columns and plural distinct sensing lines SA1˜SA9 in rows. The driving lines DA1˜DA9 and the sensing lines SA1˜SA9 are located at different layers. The driving lines DA1˜DA9 and the sensing lines SA1˜SA9 intersect with each other (i.e., each driving line DA1˜DA9 intersects with every sensing line SA1˜SA9 and each sensing line SA1˜SA9 intersects with every driving line DA1˜DA9) so as to form an electric field. For better sensing effect, preferably, the driving lines DA1˜DA9 and the sensing lines SA1˜SA9 can be arranged orthogonal to each other. As shown by the top view of FIG. 1A, the intersections where the driving lines DA1˜DA9 and the sensing lines SA1˜SA9 overlap with each other are the sensing nodes N11, N12, N13 . . . , N98, and N99. The capacitive touch sensor 11 can adopt, for example but not limited to, a so-called mutual capacitive type sensing method to sense the touched locations. The so-called mutual capacitive type sensing method is to monitor the capacitance change at each of the sensing nodes N11, N12, N13 . . . , N98, and N99 in the capacitive touch sensor 11 of the conventional capacitive touch display apparatus 10. For example, assuming that the capacitive touch sensor 11 includes J driving lines and K sensing lines, a total of (J×K) individual and spatially separated sensing nodes are thereby formed. In the example shown in FIG. 1A, the capacitive touch sensor 11 includes 9 driving lines DA1˜DA9 and 9 sensing lines SA1˜SA9, thereby forming a total of 81 individual and spatially separated sensing nodes N11, N12, N13 . . . , N98, and N99. During operation, each of the driving lines DA1˜DA9 receives a driving voltage (not shown) and because each of the driving lines DA1˜DA9 intersects with every one of the sensing lines SA1˜SA9 at the intersections (i.e., the sensing nodes N11, N12, N13 . . . , N98, and N99), a mutual capacitance is generated at each node, and a corresponding voltage can be sensed at each node. When a location on the display panel 12 is touched, the mutual capacitance of a corresponding sensing node in the capacitive touch sensor 11 changes, and the sensed voltage correspondingly changes. This feature can therefore be used to determine whether and where the display panel 12 is touched.

Still referring to FIG. 1B, as shown in the figure, the capacitive touch sensor 11 further includes a substrate 14. The sensing lines SA1˜SA9 of the capacitive touch sensor 11 can be formed at one side 141 of the substrate 14 and the driving lines DA1˜DA9 of the capacitive touch sensor 11 can be formed at an opposite side 142 of the substrate 14. In such configuration, the driving lines DA1˜DA9 and the sensing lines SA1˜SA9 do not directly contact each other; instead, the driving lines DA1˜DA9 and the sensing lines SA1˜SA9 are capacitively coupled to each other at the intersections (N11, N12, . . . , N98, N99) with the substrate 14 in between. For example, an overlapping intersection of a driving line (e.g., DA9) and a sensing line (e.g., SA9) forms a sensing node (e.g., N99) as shown in FIG. 1A and FIG. 1B. Such an intersection (i.e., a sensing node) is a position where one of the driving lines DA1˜DA9 and one of the sensing lines SA1˜SA9 cross or come nearest to each other from top view, but they are in fact at different elevation planes from cross sectional view.

In the capacitive touch sensor 11, for example, the driving line DA9 and the sensing line SA9 are capacitively coupled to each other at the sensing node N99 to generate a mutual capacitance. That is, because the voltage level of the driving line DA9 is different from that of the sensing line SA9, magnetic field lines are formed at the sensing node N99 (as shown in FIG. 1B). FIG. 1C shows an explosion view of FIG. 1B. Generally, in such a configuration wherein the capacitive touch display apparatus 10 is formed by combining the display panel 12 with the capacitive touch sensor 11, the noises generated from the display panel 12 will interfere with the capacitive touch sensor 11. FIG. 1C explains how the noises generated from the display panel 12 interfere with the capacitive touch sensor 11. As compared to a single-layer type capacitive touch sensor 11 (i.e., a capacitive touch sensor whose driving lines and sensing lines are arranged on the same side of a substrate), the two-layers type capacitive touch sensor 11 as shown in FIG. 1B and FIG. 1C can make use of the driving lines DA1˜DA9 to block the noises generated from the display panel 12 so that they do not interfere with the capacitive touch sensor 11 (e.g., as shown in FIG. 1C, the noise A coming from beneath the driving line DA1 is blocked, so that the noise A will not be capacitively coupled to the sensing line SA9 and therefore there will be no mutual capacitance generated by the noise A coupling with the sensing line SA9). However, there are gaps between two neighboring driving lines (e.g., between driving lines DA1 and DA2 or driving lines DA8 and DA9), so the noise B generated from the display panel 12 can still be capacitively coupled to the sensing lines (e.g., the sensing line SA9) of the capacitive touch sensor 11 to generate a mutual capacitance by the noise B coupling with the sensing line SA9 (e.g., as shown in FIG. 1C, the noise B can pass through the gap between driving lines DA1 and DA2 or the gap between driving lines DA8 and DA9). Thus, the capacitive touch sensor 11 is still affected by the noise B, and the conventional capacitive touch display apparatus 10 can not completely block the noises generated from the display panel 12 to prevent such noises from interfering with the capacitive touch sensor 11.

Please refer to FIG. 2A which shows a cross sectional view of another conventional capacitive touch display apparatus 20 which intends to overcome the drawback in the above-mentioned prior art. In the conventional capacitive touch display apparatus 20, a shielding layer 23 which is grounded is disposed between the display panel 22 and the capacitive touch sensor 21. FIG. 2B shows an explosion view of FIG. 2A. FIG. 2B explains the mechanism as to how the shielding layer 23 can block the noises generated from the display panel 22. As shown in FIG. 2B, the shielding layer 23 provides an electric field to attract undesirable magnetic field lines, thereby preventing the noises generated from the display panel 22 from interfering with the capacitive touch sensor 21. However, this prior art requires a shielding layer 23 to be located between the display panel 22 and the capacitive touch sensor 21, which adversely affects the visual effect of the display panel 22 and therefore degrades the performance of the capacitive touch display apparatus 20.

In view of the above, to overcome the drawbacks in the prior art, the present invention proposes a noise-shielded capacitive touch display apparatus capable of effectively blocking the noises generated from the display panel so that the noises do not interfere with the operation of the noise-shielded capacitive touch display apparatus.

### SUMMARY OF THE INVENTION

From one perspective, the present invention provides a noise-shielded capacitive touch display apparatus, comprising: a display panel; and a capacitive touch sensor on the display panel, wherein the capacitive touch sensor includes: a plurality of sensing lines, which are parallel with one another and extend along a first direction; a plurality of driving lines, which are parallel with one another and extend along a second direction, wherein the sensing lines and the driving lines intersect with each other from a top view to form an electric field, and wherein the sensing lines and the driving lines are located at different elevation planes from a cross sectional view; and a plurality of signal lines each of which is located between two neighboring driving lines of the a plurality of driving lines, wherein the signal lines and the driving lines are located at the same elevation plane from the cross sectional view; whereby an electric field wall is formed between each signal line and its neighboring driving line to block a noise generated from the display panel.

In one embodiment, the capacitive touch sensor further includes a substrate, and wherein the sensing lines are located at one side of the substrate and the driving lines and the signal lines are located at an opposite side of the substrate.

In one embodiment, the signal lines are connected to ground.

In one embodiment, a voltage level of each signal line is higher or lower than a voltage level of each driving line.

In one embodiment, each sensing line includes one or more sensing electrodes.

In one embodiment, each driving line includes one or more driving electrodes.

In one embodiment, the display panel includes a liquid crystal display (LCD) panel or an organic light emitting diode (OLED) panel.

In one embodiment, the noise-shielded capacitive touch display apparatus further includes an exterior signal line which is located at an exterior side of the driving lines and is parallel with the second direction; and/or an exterior signal line which is disposed at an exterior side of the sensing lines and is parallel with the first direction.

From another perspective, the present invention provides a noise-shielded capacitive touch display apparatus, comprising: a display panel; and a capacitive touch sensor on the display panel, wherein the capacitive touch sensor includes: a substrate; a plurality of sensing lines, which are located at a first side of the substrate and parallel with each other, and extend along a first direction; a plurality of driving lines, which are located at a second side of the substrate and parallel with each other, and extend along a second direction, wherein the second side is opposite to the first side and the sensing lines and the driving lines intersect with each other from a top view to form a capacitance electric field; and a plurality of electric field walls, each of which is formed between two neighboring driving lines of the plurality of driving lines to block a noise generated from the display panel.

In one embodiment, the driving lines form a plurality of first electrodes, and the noise-shielded capacitive touch display apparatus further includes a plurality of second electrodes each of which is located between two neighboring driving lines of the plurality of driving lines, wherein the electric field walls are respectively formed between the first electrodes and the second electrodes.

In one embodiment, each of the second electrodes includes: a signal line located between two neighboring driving lines of the plurality of driving lines, wherein the signal line has a voltage level higher or lower than voltage levels of the two driving lines.

In one embodiment, the noise-shielded capacitive touch display apparatus further comprises: an exterior signal line, which is located at an exterior side of the driving lines and is parallel with the second direction, wherein the exterior signal line has a voltage level higher or lower than a voltage level of the driving line closest to the exterior signal line, so as to form an exterior electric field wall which is parallel with the second direction.

In one embodiment, the noise-shielded capacitive touch display apparatus further comprises: an exterior signal line, which is located at an exterior side of the sensing lines and is parallel with the first direction, wherein the exterior signal line has a voltage level higher or lower than a voltage level of each driving line, so as to form an exterior electric field wall which is parallel with the first direction.

The objectives, technical details, features, and effects of the present invention will be better understood with regard to the detailed description of the embodiments below, with reference to the attached drawings.

### BRIEF DESCRIPTION OF THE DRAWINGS

FIG. 1A shows a top view of a conventional capacitive touch display apparatus.

FIG. 1B shows a cross sectional view of a conventional capacitive touch display apparatus.

FIG. 1C shows an explosion view of FIG. 1B.

FIG. 2A shows a cross sectional view of another conventional capacitive touch display apparatus.

FIG. 2B shows an explosion view of FIG. 2A.

FIG. 3A shows a top view of a noise-shielded capacitive touch display apparatus according to an embodiment of the present invention.

FIG. 3B shows a cross sectional view of a noise-shielded capacitive touch display apparatus according to an embodiment of the present invention.

FIG. 3C shows an explosion view of FIG. 3B.

FIG. 4A shows a top view of a noise-shielded capacitive touch display apparatus according to another embodiment of the present invention.

FIG. 4B shows a cross sectional view of a noise-shielded capacitive touch display apparatus according to another embodiment of the present invention.

FIG. 4C shows an explosion view of FIG. 4B.

### DESCRIPTION OF THE PREFERRED EMBODIMENTS

The above and other technical details, features and effects of the present invention will be will be better understood with regard to the detailed description of the embodiments below, with reference to the drawings. In the description, the words related to directions such as “upper”, “lower”, “left”, “right”, “forward”, “backward”, etc. are used to illustrate relative orientations in the drawings and should not be considered as limiting in any way. The drawings as referred to throughout the description of the present invention are for illustration only, to show the interrelations between the apparatus and the devices, but not drawn according to actual scale.

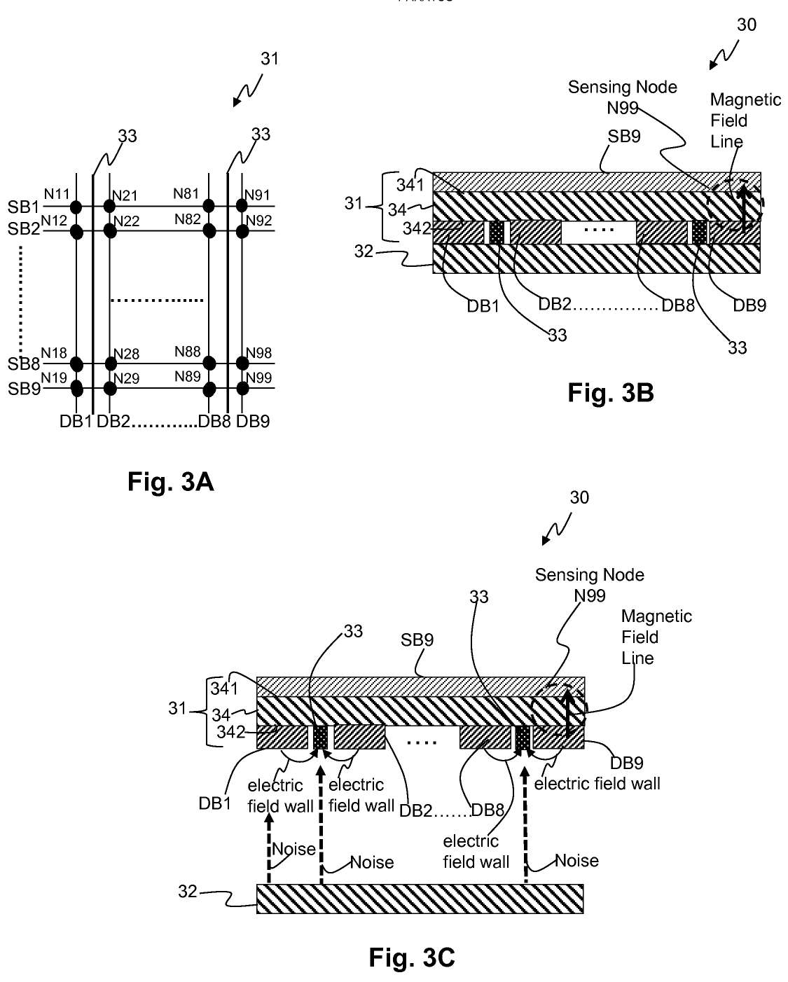

Please refer to FIG. 3A and FIG. 3B. FIG. 3A shows a top view of a noise-shielded capacitive touch display apparatus according to an embodiment of the present invention. FIG. 3B shows a cross sectional view of a noise-shielded capacitive touch display apparatus according to an embodiment of the present invention. The noise-shielded capacitive touch display apparatus 30 shown in FIG. 3B can be, for example, a mutual capacitance type touch panel. Generally, the noise-shielded capacitive touch display apparatus 30 comprises a capacitive touch sensor 31 and a display panel 32. The capacitive touch sensor 31 is located on the display panel 32. In one embodiment, the capacitive touch sensor 31 and the display panel 32 can be laminated to each other through, for example but not limited to, a transparent adhesive. Only the capacitive touch sensor 31 of the conventional capacitive touch display apparatus 30 is shown in the top view of FIG. 3A, because the display panel 32 is located below the capacitive touch sensor 31 (as shown in FIG. 3B) and can not be seen from the top view of FIG. 3A. The display panel 32 can be, for example but not limited to, a liquid crystal display (LCD) panel or an organic light emitting diode (OLED) panel.

The capacitive touch sensor 31 includes plural driving lines DB1˜DB9 in columns and plural sensing lines SB1˜SB9 in rows. In the capacitive touch sensor 31, the sensing lines SB1˜SB9 are parallel with each other and extend along a first direction (e.g., in this embodiment, the first direction is a lateral direction), and the driving lines DB1˜DB9 are parallel with each other and extend along a second direction (e.g., in this embodiment, the second direction is a longitudinal direction). In a preferable embodiment, the above-mentioned first direction and second direction are orthogonal to each other; however, this is preferred but not absolutely necessary. It suffices as long as the sensing lines SB1˜SB9 and the driving lines DB1˜DB9, from the top view of FIG. 3A, intersect with each other. As shown in FIG. 3A, the driving lines DB1˜DB9 and the sensing lines SB1˜SB9 intersect with each other to form an electric field, and as shown in FIG. 3B, the driving lines DB1˜DB9 and the sensing lines SB1˜SB9 are located at different elevation planes. To enhance the capacitive sensing efficiency, the driving lines DB1˜DB9 and the sensing lines SB1˜SB9 are preferably arranged orthogonal to each other. For this reason, the orthogonal arrangement is shown in the embodiments; however, this is for illustration but not for limiting the scope of the present invention. In one embodiment, each of the sensing lines SB1˜SB9 includes one or more sensing electrodes, and each of the driving line DB1˜DB9 includes one or more driving electrodes. The sensing electrodes or a portion of the sensing electrodes can be made of, for example, one or more metal conductive meshes or Indium Tin Oxide (ITO). The driving electrodes or a portion of the driving electrodes can be made of, for example, one or more metal conductive meshes or Indium Tin Oxide (ITO) . The above-mentioned metal conductive meshes can include copper, silver or other conductive materials. The sensing electrodes and the driving electrodes can be located at any positions depending on layout requirements and circuit design. For example, the sensing electrodes can be located at two ends of the sensing lines SB1˜SB9 and the driving electrodes can be located at two ends of the driving lines DB1˜DB9.

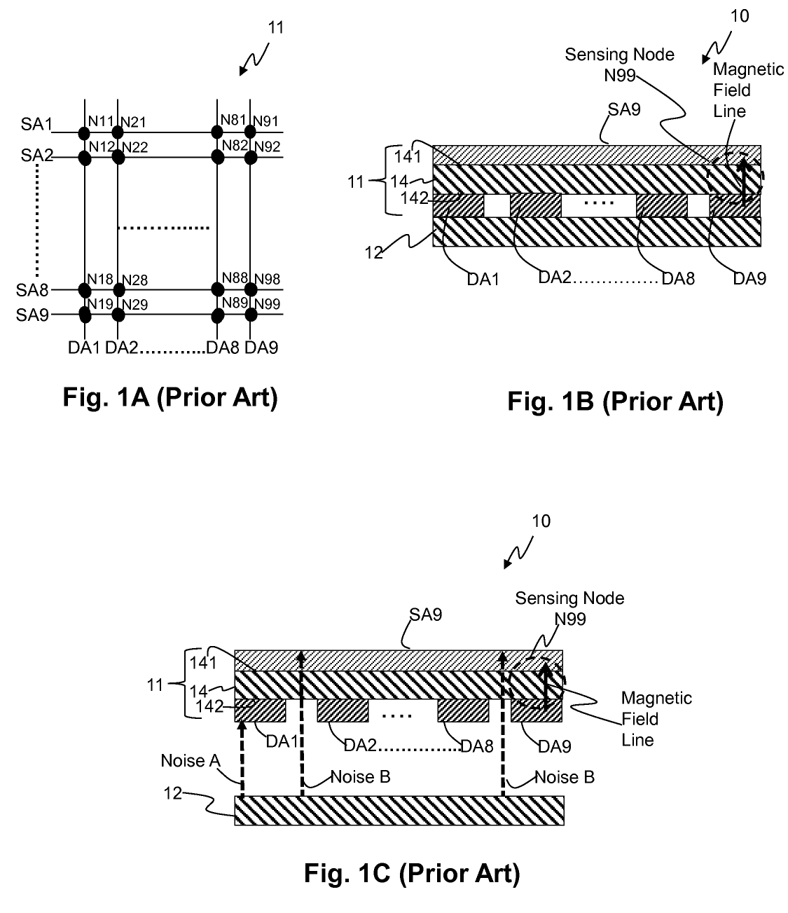

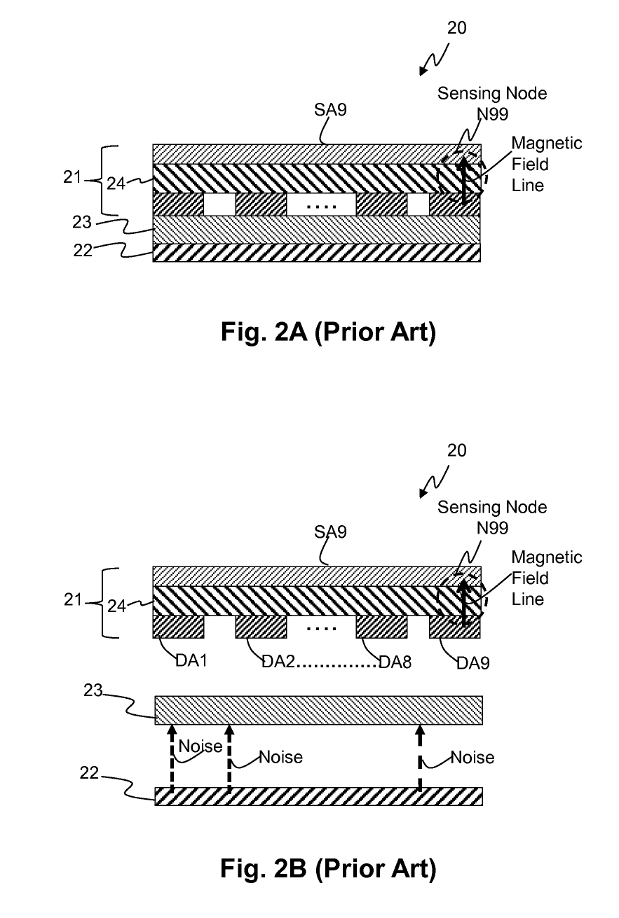

As compared with the conventional capacitive touch device 10 shown in FIGS. 1A-1C and the conventional capacitive touch device 20 shown in FIGS. 2A-2B, the noise-shielded capacitive touch display apparatus 30 in this embodiment further includes plural signal lines 33 located between every two neighboring driving lines (shown in the figure between the two neighboring driving lines DB1 and DB2 and between the two neighboring driving lines DB8 and DB9 for illustration). That is, for example, a signal line 33 is located between the two neighboring driving lines DB1 and DB2, and another signal line 33 is located between the two neighboring driving lines DB2 and DB3 (not shown), and so on, so that there is a signal line 33 between every two neighboring driving lines (The features and the advantages of the signal lines 33 will be discussed later). As shown in FIG. 3A, each signal line 33 is parallel with the above-mentioned longitudinal direction; the signal lines 33 and the sensing lines SB1˜SB9 are orthogonal to each other, and the signal lines 33 and the driving lines DB1˜DB9 are parallel with each other. The signal lines 33 and the driving lines DB1˜DB9 are located at the same elevation plane from the cross sectional view of FIG. 3B. (“At the same elevation plane” does not require that the signal lines 33 and the driving lines DB1˜DB9 must have the same thickness.) Note that it is preferred, but not absolutely necessary, that each signal line 33 is parallel with the above-mentioned longitudinal direction. In another embodiment, the signal lines 33 do not have to be parallel with the driving lines DB1˜DB9 from the top view of FIG. 3A; instead, it is only required that there is a signal line 33 between every two neighboring driving lines. In addition, although it is more convenient for layout design for the signal line 33 to be a straight line, the signal line 33 is not limited to be a straight line; the signal line 33 can be in the form of multiple lumps, multiple discontinuous segments, a zig-zag line, or a line having irregular width.

Still referring to FIGS. 3A-3B, the intersections where the driving lines DB1˜DB9 and the sensing lines SB1˜SB9 overlap with each other are the sensing nodes N11, N12, N13 . . . , N98, and N99. The capacitive touch sensor 31 can adopt, for example but not limited to, a so-called mutual capacitive type sensing method to sense the touched locations. The so-called mutual capacitive type sensing method is to monitor the capacitance change at each of the sensing nodes N11, N12, N13 . . . , N98, and N99 in the capacitive touch sensor 31 of the capacitive touch display apparatus 30. For example, assuming that the capacitive touch sensor 31 includes J driving lines and K sensing lines, a total of (J×K) individual and spatially separated sensing nodes are thereby formed. In the example shown in FIG. 3A, the capacitive touch sensor 31 includes 9 driving lines DB1˜DB9 and 9 sensing lines SB1˜SB9, thereby forming a total of 81 individual and spatially separated sensing nodes N11, N12, N13″, N98, and N99. During operation, each of the driving lines DB1˜DB9 receives a driving voltage (not shown) and because each of the driving lines DB1˜DB9 intersects with every one of the sensing lines SB1˜SB9 at the intersections (i.e., the sensing nodes N11, N12, N13″, N98, and N99), a mutual capacitance is generated at each node, and a corresponding voltage can be sensed at each node. Note that the driving lines DB1˜DB9 do not directly contact the sensing lines SB1˜SB9; an intersection where one of the driving lines DB1˜DB9 (e.g. DB9) intersects with one of the sensing lines SB1˜SB9 (e.g. SB9) is an overlapping location from top view, which forms a sensing node (e.g. N99), but the driving lines DB1˜DB9 and the sensing lines SB1˜SB9 are in fact located at different elevation planes from cross sectional view. When a location on the display panel 32 is touched, the mutual capacitance of a corresponding sensing node in the capacitive touch sensor 31 changes, and the sensed voltage correspondingly changes. This feature can therefore be used to determine whether and where the display panel 32 is touched. Note that the number of the driving lines DB1˜DB9 and the number of the sensing lines SB1˜SB9 are for illustrative purpose only, and the present invention is of course not limited to these numbers.

As shown in FIG. 3B, the capacitive touch sensor 31 further includes a substrate 34. The sensing lines SB1˜SB9 of the capacitive touch sensor 31 can be located at one side 341 of the substrate 34 and the driving lines DB1˜DB9 of the capacitive touch sensor 31 can be located at an opposite side 342 of the substrate 34. That is, the substrate 34 is located between an elevation plane including the sensing lines SB1˜SB9 and another elevation plane including the driving lines DB1˜DB9. The sensing lines SB1˜SB9, the substrate 34 and the driving lines DB1˜DB9 are stacked from top to bottom in the described order as shown in FIG. 3B to form the noise-shielded capacitive touch display apparatus 30. This embodiment is different from the conventional capacitive touch device 10 shown in FIGS. 1A-1C and different from the conventional capacitive touch device 20 shown in FIGS. 2A-2B in that the capacitive touch sensor 31 of the noise-shielded capacitive touch display apparatus 30 further includes plural signal lines 33. The cross sectional view of FIG. 3B shows that, preferably, the signal lines 33 and the driving lines DB1˜DB9 are located at the same side 342 of the substrate 34, and each of the signal lines 33 is located between two neighboring driving lines (two examples are show between the driving lines DB1 and DB2 and between the driving lines DB8 and DB9).

In one embodiment, the substrate 34 can be a transparent insulating thin plate whose material can be selected from the group consisting of, for example but not limited to: glass, polycarbonate (PC), polyester (PET), polymethyl methacrylate (PMMA) or cyclic olefin copolymer (COC).

FIG. 3C shows an explosion view of FIG. 3B for explaining how the noise-shielded capacitive touch display apparatus 30 of this embodiment, by providing the signal lines 33, effectively blocks the noises generated from the display panel 32. Referring to FIGS. 3B and 3C, the signal lines 33 and the driving lines DB1˜DB9 are located at the same side 342 of the substrate 34; that is, each of the signal lines 33 is located on the same side 342 as each of the driving lines DB1˜DB9 but is located on the opposite side with respect to the sensing lines SB1˜SB9, or in other words, each of the signal lines 33 is located on the same elevation plane with the driving lines DB1˜DB9 and between two neighboring driving lines (as shown by two examples between the driving lines DB1 and DB2 and between the driving lines DB8 and DB9) but does not directly contact the driving lines DB1˜DB9. Hence, there is one signal line 33 between every two neighboring driving lines. The thickness of each signal line 33 can be the same as or different from that of each driving line DB1˜DB9. In one embodiment, the signal lines 33 can be made from a copper foil plate or a flexible printed circuit (FPC).

Importantly, each of the signal line 33 is at a voltage level higher or lower than the voltage level of each of the driving line DB1˜DB9. For example, the signal lines 33 can be, for example but not limited to, connected to ground so that the signal lines 33 substantially have a ground potential (because there may be intrinsic resistances in the signal lines 33 which may cause a deviation of the voltage level, although the signal lines are connected to ground, they may not be exactly at 0V). Thus, electric field walls can be respectively formed between the driving lines DB1˜DB9 and the corresponding signal lines 33 (as shown in FIG. 3C). Each of the driving lines DB1˜DB9 can be regarded as a first electrode (i.e., an upper electrode) of each electric field wall, while each of the signal lines 33 can be regarded as a second electrode (i.e., a lower electrode) of each electric field wall. For example, as shown in FIG. 3C, a signal line 33 is located between two neighboring driving lines DB1 and DB2, whereby an electric field wall is formed between the driving line DB1 and the signal line 33, and another electric field wall is also formed between the driving line DB2 and the same signal line 33. The driving lines DB1 and DB2 can be regarded as the respective first electrodes (i.e., the upper electrodes) of the electric field walls, whereas the signal line 33 can be regarded as the second electrode (i.e., the lower electrode) of each electric field wall. Or, for another example, as shown in FIG. 3C, a signal line 33 is located between two neighboring driving lines DB8 and DB9, whereby an electric field wall is formed between the driving line DB8 and the signal line 33, and another electric field wall is also formed between the driving line DB9 and the same signal line 33. The driving lines DB8 and DB9 can be regarded as the respective first electrodes (i.e., the upper electrodes) of the electric field walls, whereas the signal line 33 can be regarded as the second electrode (i.e., the lower electrode) of each electric field wall. As such, a signal line 33 is provided between every two neighboring driving lines (i.e., between the driving lines DB1 and DB2, between the driving lines DB2 and DB3, . . . ,and between the driving lines DB8 and DB9), and thus an electric field is formed between every two neighboring driving lines. Consequently, these electric field walls provide an electric field to attract noises generated from the display panel 32, thereby blocking these noises to prevent these noises from interfering with the capacitive touch sensor 31.

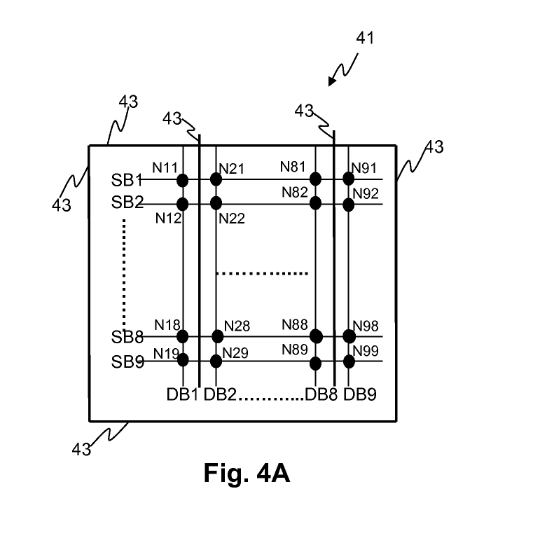

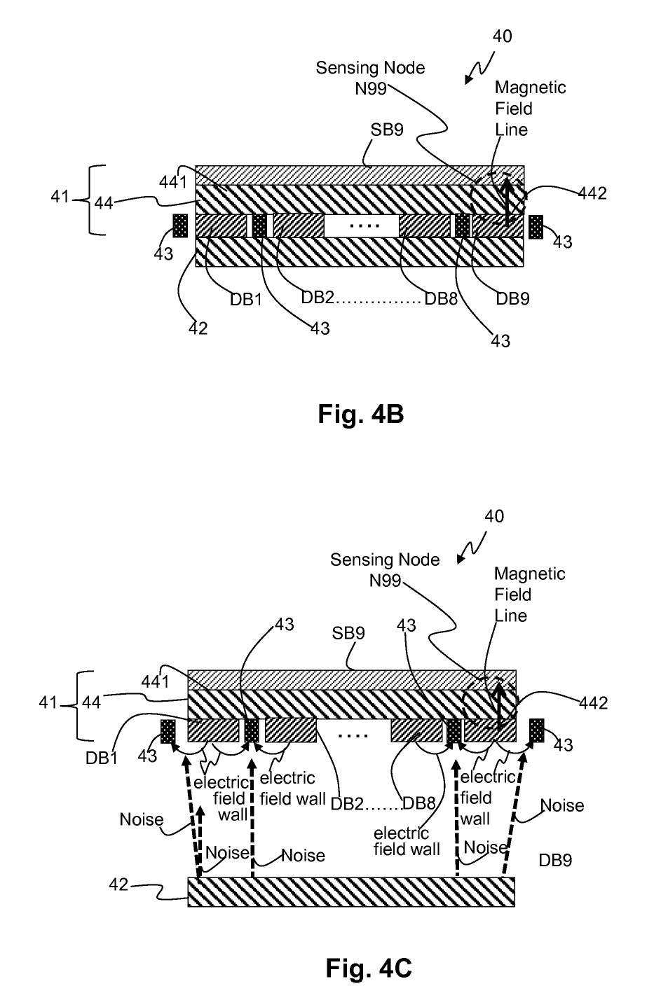

Please refer to FIGS. 4A-4C. FIG. 4A shows a top view of a noise-shielded capacitive touch display apparatus according to another embodiment of the present invention. FIG. 4B shows a cross sectional view of a noise-shielded capacitive touch display apparatus according to another embodiment of the present invention. FIG. 4C shows an explosion view of FIG. 4B. As shown in FIGS. 4A-4B, in the capacitive touch sensor 41, each of the signal lines 43 and the driving lines DB1˜DB9 are located at the same side 442 of the substrate 44 (i.e., each of the signal lines 43 is located on the same side 442 as the driving lines DB1˜DB9 but are located on the opposite side with respect to the sensing lines SB1˜SB9). This embodiment is different from the previous embodiment in that, in additional to the signal lines 43 similar to the signal lines 33 of the previous embodiment, there are exterior signal lines 43 located at one or both exterior sides of the driving lines DB1 and DB9 and at one or both exterior sides of the sensing lines SB1 and SB9. That is, as shown by the top view of FIG. 4A in addition to the signal lines 43 between every two neighboring driving lines (i.e., between the driving lines DB1 and DB2, between the driving lines DB2 and DB3, . . . , and between the driving lines DB8 and DB9), at least one exterior signal line 43 is provided at an exterior side of the driving line DB1 or DB9 and is parallel with a longitudinal direction (there are two signal lines 43 provided at both exterior sides of the driving lines DB1 and DB9 in the shown example) and/or at least one exterior signal line 43 is provided at an exterior side of the sensing lines SB1 or SB9 and is parallel with a lateral direction (there are two signal lines 43 provided at both exterior sides of the sensing lines SB1 and SB9 in the shown example). As a consequence, as shown in FIG. 4C, in addition to the electric field walls formed between the driving lines DB1˜DB9 and the signal lines 43 between the driving lines DB1˜DB9, for example, an electric field wall can be formed between the driving line DB1 and the exterior signal line 43 located at the exterior side (the side opposite to the driving line DB2) of the driving line DB1. For another example, an electric field wall can be formed between the driving line DB9 and the exterior signal line 43 located at the exterior side (the side opposite to the driving line DB8) of the driving line DB9. Or, for yet another example, an electric field wall can be formed between each of the driving lines DB1˜DB9 and the exterior signal line 43 located at the exterior side (the side opposite to the sensing line SB2) of the sensing line SB1 (which is not shown in FIGS. 4B-4C due to the perspective). For still another example, an electric field wall can be formed between each of the driving lines DB1˜DB9 and the exterior signal line 43 located at the exterior side (the side opposite to the sensing line SB8) of the sensing line SB9 (which is not shown in FIGS. 4B-4C due to the perspective). Consequently, these electric field walls can provide an electric field to attract noises generated from the display panel 42, thereby blocking the noises to prevent the noises from interfering with the capacitive touch sensor 41.

The feature of the present invention to provide a signal line 33 between two neighboring driving lines has an advantageous effect that electric field walls can be formed between the driving lines DB1˜DB9 and the signal lines 33 between the driving lines DB1˜DB9. As compared with the conventional capacitive touch device 20 (as shown in FIG. 2B), the present invention does not need to dispose a shielding layer 23 between the display panel 32 and the capacitive touch sensor 31. Without the shielding layer 23, the present invention can completely block the noises generated from the display panel 32 by the electric field walls formed between the driving lines DB1˜DB9 and the signal lines 33 between the driving lines DB1˜DB9. From the perspective of manufacture, preferably but not necessarily, the signal lines and the driving lines DB1˜DB9 can be manufactured by same process steps, so the manufacturing cost is not increased this is another advantage over the prior art using the shielding layer 23 as shown in FIG. 2B.

The present invention has been described in considerable detail with reference to certain preferred embodiments thereof. It should be understood that the description is for illustrative purpose, not for limiting the scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, in the embodiment shown in FIGS. 4A-4C, it is not required to provide the exterior signal lines 43 at all four exterior sides; instead, the exterior signal line(s) 43 can be provided at one exterior side, two exterior sides or three exterior sides. Also, it is not required for an exterior signal line 43 to be entirely connected to another exterior signal line 43; instead, there can be an opening between two neighboring exterior signal lines 43. For another example, in the embodiments shown in FIG. 3A and FIG. 4A, the signal line 33 and the signal line 43 are not required to completely or entirely extend along the gap between two neighboring driving lines; instead, the signal line 33 and the signal line 43 can extend discontinuously or incompletely, which still can shield noises. In view of the foregoing, the spirit of the present invention should cover all such and other modifications and variations, which should be interpreted to fall within the scope of the following claims and their equivalents.

What is claimed is:

1. A noise-shielded capacitive touch display apparatus, comprising:
a display panel; and
a capacitive touch sensor on the display panel, wherein the capacitive touch sensor includes:
a plurality of sensing lines, which are parallel with one another and extend along a first direction;
a plurality of driving lines, which are parallel with one another and extend along a second direction, wherein each of the sensing lines intersects with each of the driving lines from a top view to form an electric field, and wherein the sensing lines and the driving lines are located at different elevation planes from a cross sectional view; and
a plurality of signal lines each of which is located between two neighboring driving lines of the a plurality of driving lines, wherein the signal lines and the driving lines are located at the same elevation plane from the cross sectional view;
whereby an electric field wall is formed between each signal line and its neighboring driving line to block a noise generated from the display panel.

2. The noise-shielded capacitive touch display apparatus of claim 1, wherein the capacitive touch sensor further includes a substrate, and wherein the sensing lines are located at one side of the substrate and the driving lines and the signal lines are located at an opposite side of the substrate.

3. The noise-shielded capacitive touch display apparatus of claim 1, wherein the signal lines are connected to ground.

4. The noise-shielded capacitive touch display apparatus of claim 1, wherein a voltage level of each signal line is higher or lower than a voltage level of each driving line.

5. The noise-shielded capacitive touch display apparatus of claim 1, wherein each sensing line includes one or more sensing electrodes.

6. The noise-shielded capacitive touch display apparatus of claim 1, wherein each driving line includes one or more driving electrodes.

7. The noise-shielded capacitive touch display apparatus of claim 1, wherein the display panel includes a liquid crystal display (LCD) panel or an organic light emitting diode (OLED) panel.

8. The noise-shielded capacitive touch display apparatus of claim 1, further including an exterior signal line which is located at an exterior side of the driving lines and is parallel with the second direction.

9. The noise-shielded capacitive touch display apparatus of claim 1, further including an exterior signal line which is located at an exterior side of the sensing lines and is parallel with the first direction.

10. The noise-shielded capacitive touch display apparatus of claim 1, wherein:
the sensing lines and the driving lines are orthogonal to each other from the top view;
the signal lines are parallel with the second direction;
the signal lines and the sensing lines are orthogonal to each other from the top view; and
the signal lines and the driving lines are parallel with each other from the top view.

11. A noise-shielded capacitive touch display apparatus, comprising:
a display panel; and
a capacitive touch sensor on the display panel, wherein the capacitive touch sensor includes:
a substrate;
a plurality of sensing lines, which are located at a first side of the substrate and parallel with each other, and extend along a first direction;
a plurality of driving lines, which are located at a second side of the substrate and parallel with each other, and extend along a second direction, wherein the second side is opposite to the first side and the sensing lines and the driving lines intersect with each other from a top view to form a capacitance electric field; and
a plurality of electric field walls, each of which is formed between two neighboring driving lines of the plurality of driving lines to block a noise generated from the display panel.

12. The noise-shielded capacitive touch display apparatus of claim 11, wherein the driving lines form a plurality of first electrodes, and the noise-shielded capacitive touch display apparatus further includes a plurality of second electrodes each of which is located between two neighboring driving lines of the plurality of driving lines, and wherein the electric field walls are respectively formed between the first electrodes and the second electrodes.

13. The noise-shielded capacitive touch display apparatus of claim 12, wherein each of the second electrodes includes:
a signal line located between two neighboring driving lines of the plurality of driving lines, wherein the signal line has a voltage level higher or lower than voltage levels of the two driving lines.

14. The noise-shielded capacitive touch display apparatus of claim 13, wherein:
the sensing lines and the driving lines are orthogonal to each other from the top view;
the signal lines are parallel with the second direction;
the signal lines and the sensing lines are orthogonal to each other from the top view; and
the signal lines and the driving lines are parallel with each other from the top view.

15. The noise-shielded capacitive touch display apparatus of claim 11, further comprising:
an exterior signal line, which is located at an exterior side of the driving lines and is parallel with the second direction, wherein the exterior signal line has a voltage level higher or lower than a voltage level of the driving line closest to the exterior signal line, so as to form an exterior electric field wall which is parallel with the second direction.

16. The noise-shielded capacitive touch display apparatus of claim 11, further comprising:
an exterior signal line, which is located at an exterior side of the sensing lines and is parallel with the first direction, wherein the exterior signal line has a voltage level higher or lower than a voltage level of each driving line, so as to form an exterior electric field wall which is parallel with the first direction.
